(19) United States
(12) Patent Application Publication
(10) Pub. No.: US 2026/0054828 A1
(43) Pub. Date: Feb. 26, 2026

(54) Solar Towed Aerial Platforms

(71) Applicants: Galen Suppes, Charlottesville, VA (US); Adam B. Suppes, Chicago, IL (US)

(72) Inventors: Galen Suppes, Charlottesville, VA (US); Adam B. Suppes, Chicago, IL (US)

(73) Assignees: Adam B. Suppes, Chicago, IL (US); The Suppes Family Trust, Charlottesville, VA (US)

(21) Appl. No.: 19/047,933

(22) Filed: Feb. 7, 2025

Related U.S. Application Data
(63) Continuation of application No. 17/795,612, filed on Jul. 27, 2022, now Pat. No. 12,330,798.

(51) Int. Cl. B64C 19/02; B64D 3/00; B64U 10/20; B64U 20/70; B64U 30/10; B64U 30/12; B64U 30/293; B64U 30/297; B64U 50/31; B64U 60/50; B64U 101/60

(52) U.S. Cl. CPC B64C 19/02; B64D 3/00; B64U 20/70; B64U 30/297; B64U 50/31; B64U 10/20; B64U 30/10; B64U 30/12; B64U 30/293; B64U 60/50; B64U 2101/60

(57) ABSTRACT

An aerial towed platform flies behind a lead vehicle collecting more power than needed to overcome the drag of the towed platform. The towed platform planform is comprised mostly of a single photovoltaic sheet with lift forces on both the upper and lower surface of the sheet. The camber of the platform is preferably between 0.02 and 0.06 with distributed propulsion able to change camber continuity and increase lift relative to drag. The applications include, but is not limited to, aircraft, trucks, cars, railcars, and boats. The most-preferred application is vehicles with low drag where the solar power can provide more than 30% of the energy needs of the vehicle.

### CROSS REFERENCE TO RELATED APPLICATIONS

This application is a continuation in part of applications U.S. Ser. No. 17/795,612 (27-JUL.-2022), PCT/US24/62323 (30-DEC.-2024), and PCT/US24/35242 (24-JUN.-2024). Direct priority is claimed on Provisional Appl. Ser. Nos. 63/554,100 (15-FEB.-2024), 63/649,487 (20-MAY-2024), (24-JUN.-2024), 63,678,615 (01-AUG.-2024), 63/721,051 (15-NOV.-2024), 63/729,403 (08-DEC.-2024), and 63/752,896 (03-FEB.-2025). Indirect priority through active applications is claimed to Provisional Appl. Ser. Nos. 63/212,138 (18-JUN.-2021), Ser. No. 63/279,397 (15-NOV.-2021), 63523094 (filed 25-JUN.-2023), 63530177 (01-AUG.-2023), 63532922 (16-AUG.-2023), 63535370 (30-AUG.-2023), 63541405 (29-SEP.-2023), 63/605,544 (03-DEC.-2023), and 63/616,719 (31-DEC.-2023) as well as PCT/US21/16392 (03-FEB.-2021).

### FIELD

The present invention relates to generation of aerodynamic lift and reduction of drag using air flow around lifting bodies including trucks, boats, railcars, and aircraft.

### BACKGROUND

As the drag and rolling resistance of electric vehicles decrease, photovoltaic cells are able to have increasing impact on reducing battery weights and costs in applications with high solar radiance. Also, the impact of towed solar panels has increasing value. In some applications, like trucks, retractable solar panels are retracted at low speeds and extended at higher speeds.

Instant invention builds upon several patent applications toward improved solar towed platforms for use in a wider range of vehicles.

### SUMMARY OF THE INVENTION

Instant invention consists of a system comprised of ground effect machines (GEM) and a control means based on clearance with the ground. The term “ground′ is applied broadly, as is typical for ground effect machine literature, and includes the ground, water's surface, roadways, waterways, railways, and other coverings of Earth's surface.

The base case ground-effect flight vehicle consists of a lower surface cavity configured to contain pressure, an upper-surface propulsor, and a forward upper surface configured to generate induced thrust. The lower surface cavity is comprised of a port fence, a starboard fence, and a trailing edge flap said trailing edge flap having a trailing flap edge. The ground-effect aircraft is configured to operate with the chord connecting the forward stagnation point to the trailing flap edge at a pitch between 0° and 3°.

An upper surface propulsor pushes air behind the vehicle toward eliminating boundary layer separation with flow downward and rearward along a high-pitch discharge surface extending from the propulsor discharge to a trailing edge where the flow impacts underbody air flow and the ground to create a trailing-edge stagnation point. A stagnation region having a pressure higher than surrounding pressure extends from the ground to the trailing edge. Preferably, the stagnation region extends forward through the lower surface cavity from the trailing edge to a leading edge.

GEM of the system may take free flight including takeoff in a ground-effect flight mode. The invention includes a wing gimble able to transform a laterally-extending wing in a free-flight configuration to a fence on the lower cavity of a GEM in a GEM configuration. The GEM configuration provides a high lift-drag efficiency at a low aspect ratio enabling travel on highways and railways including takeoff and landing on highways and railways.

Some of the priority applications use the term flat plate airfoil; the term thin cambered wing section is used in instant application in lieu of flat plate airfoil. A thin cambered wing section preferably has a camber between 0 and 0.08, and more preferably between 0.02 and 0.06 (i.e., 2% to 6%). The thickness of the wing section is the thickness of the sheet, while the height takes into account the camber. A flap effectively increases the camber of a thin cambered wing section. Towed platforms are more-preferably comprised of large sections of planform area of single sheet construction where lift is generated on both upper and lower surfaces, where sheet thicknesses may be less than 5 mil, and where average thicknesses including structural ribs and spars are preferably less than 5% of the maximum chord.

The ribs and spars are configured similar to the wing of a bat where upper and lower surfaces form a thin skin between structural elements that are streamlined with the thin skin which is also referred to as a sheet. A longitudinally-extending ribs preferably attach to a spanwise extending spar where multiple ribs may attach to a leading spar with the cross section area of the ribs decrease with increasing distance from the spar to which the ribs are attached.

For steady-state horizontal flight, air's angle of attack is equal to pitch. A thin cambered wing section at a low pitch is able to generate high lift relative to drag, where the lift-to-drag ratios (“L:D”) can approach the reciprocal of the pitch value in radians. Preferred cruising pitch angles are between 0.01 and 5 degrees, more preferably between 0.05 and 2 degrees, and most-preferably between 0.1 and 1 degree. Particularly advantageous applications of thin cambered wing sections are at low, evenly-distributed loads that are towed by a forward hinge joint that enables aerodynamic forces to balance lift with load to attain flight at optimal pitches.

### FIGURES

FIG. 1 illustrates a GEM 5 on tracks from: a) below and b) above.

FIG. 2 illustrates a GEM 5 with fences and mid-chord flap.

FIG. 3 is a flying towed platform train of FIG. 1 illustrating lead vehicle, primary aerial towed platform, and second aerial towed platform as disconnected units.

FIG. 4 is an illustration of part of one side of an aerial towed platform as a) two sides stacked one top the other and b) a single side.

FIG. 5 is an illustration of the trailing end of the side with a lower guide and bumper.

FIG. 6 is an illustration of flying towed platform train.

FIG. 7 illustrates a towed platform aircraft with crossover propulsor and solar panels.

FIG. 8 illustrates GEM 5 with wings that fold down with wings extended.

FIG. 9 illustrates GEM 5 with wings that fold down with wings folded down.

FIG. 10 illustrates fence additions to the FIG. 7 aircraft.

FIG. 11 illustrates vehicle with center fuselage and lateral wings with slats: a) extended

FIG. 12 illustrates a golf cart with Lift Span Tech and cavity.

FIG. 13 illustrates a thin airfoil GEM 5 with wings that fold down.

FIG. 14 is an illustration of a thin cambered wing section aircraft with four stacked platforms on the primary thin cambered wing section platform.

FIG. 15 illustrates a catamaran boat designed for ground-effect flight with extendable slats and flaps where: a) is slat extended and b) is slat retracted.

FIG. 16 illustrates a passively-adjusting lift span.

FIG. 17 illustrates a lead aircraft option for towing a platform. CG is center of gravity, CP is center of pressure, CT is center of tow force, and S is propulsion thrust.

FIG. 18 illustrates an alternative pivot connection of a lead aircraft.

FIG. 19 illustrates distributed propulsion for forming jet discharges.

FIG. 20 illustrates a thin cambered lifting body aircraft with wings.

FIG. 21 illustrates a thin aircraft with pivot, fuselage, and variation in pitch for leading, middle, and trailing sections.

FIG. 22 illustrates configurations form platform train to transformer drone.

FIG. 23 illustrates conductive laminate sheets and connections.

FIG. 24 is an illustration of a towed aerial platform attached above a fuselage.

FIG. 25 illustration of bifacial towed sheet as towed by a ground vehicle.

FIG. 26 compares: a) a cross-over propulsor to b) a Lift Span propulsor.

FIG. 27 illustrates a GEM with wing shoulder joints in a wings-as-fences configuration.

FIG. 28 Single sheet construction showing frame with and without fuselage.

FIG. 29 Vehicle with two towed platforms as an extended version of FIG. 14 illustrating stacked platforms in retracted state.

FIG. 30 Cross section of thin cambered wing section illustrating lift-span tech at the trailing section.

### DEFINITIONS

This document uses definitions and abbreviations of patent application PCT/US24/35242. The embodiments range from trucks that travel mostly on highways to wing-in-ground maritime aircraft; and due to this range, a range of terms are commonly used which generally refer to the same vehicle features. Also, for ground effect machines, the ground refers to Earth's surface and surface features such as a highway, a railway, and a waterway. With applications ranging from trucks to aircraft and with founding of an alternative fundamental's foundation there is a wide range of terms referring to devises that are fundamentally the same. The last paragraph of this document cross-references terms to facilitate relating terms over the range of applications.

### DETAILED EMBODIMENT

The instant invention is a towed solar platform configured to power a lead vehicle. The invention may be applied to a transit system comprising a ground effect machine (GEM 5) and a means to control the path along a path surface broadly referred to as the ground.

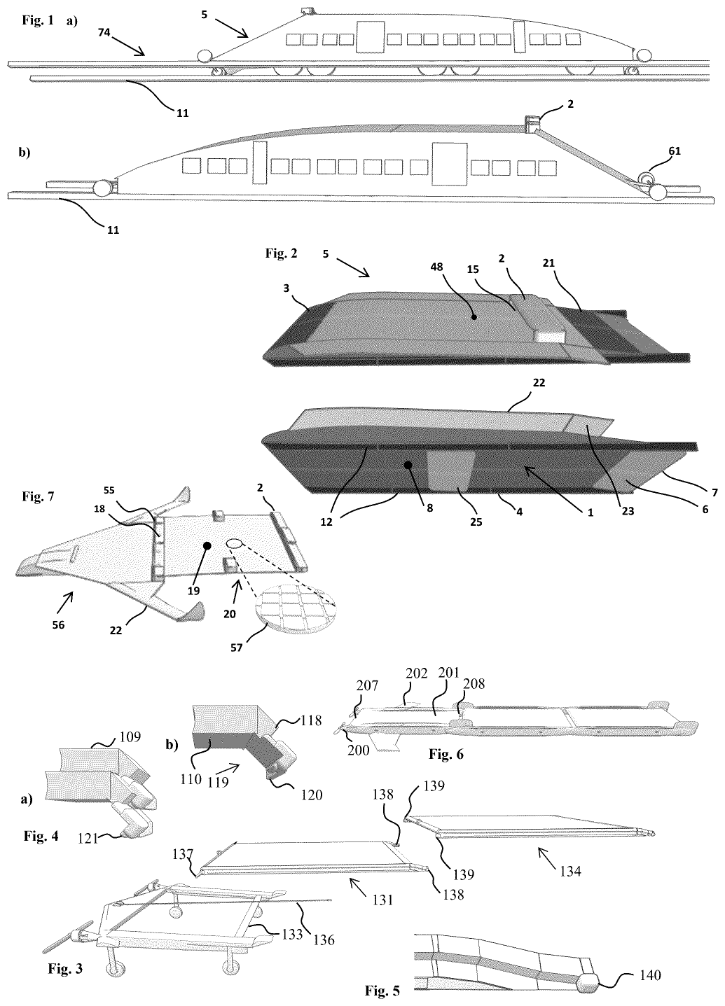

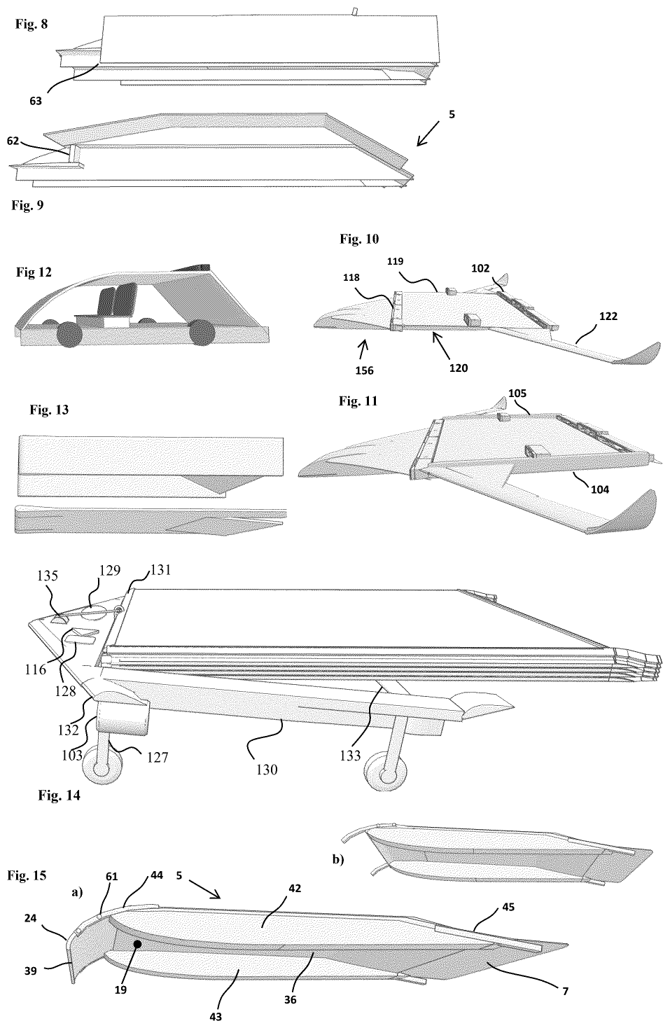

The instant invention comprises a GEM 5 (e.g., FIG. 1) having a lower surface extending lengthwise along an underside of the vehicle from a forward stagnation point to a trailing edge flap, the lower surface bounded on the portside by a portside fence, and the lower surface bounded on the starboard side by a starboard side fence. The portside fence extends downward from the lower surface along the portside of the lower surface and abuts against a portside edge of the trailing edge, and the starboard fence extends downward from the lower surface along the starboard side of the lower surface and abuts against a starboard edge of the trailing edge. The lower surfaces, the portside fence, the starboard fence, and the trailing edge flap are configured to form a cavity underneath the vehicle and contain pressure during flight.

The GEM 5 has an upper surface extending lengthwise along an upper side of the vehicle from the forward stagnation point to the trailing edge flap and further comprising an upper-surface propulsor operably connected to the upper surface. The upper surface has a forward upper surface portion proximal the stagnation point, wherein the forward upper surface is configured to generate induced thrust.

The GEM's 5 lower surface can be substantially flat surface with a pitch of 0° to 3°, relative to a horizontal pitch of 0°. A key feature to maximize L/D is a trailing edge flap having a lower surface than the vehicle's lower surface.

In an alternative sequence of limitations, the instant invention includes a GEM 5 having a lower surface 8 cavity 1 configured to contain pressure, an upper-surface propulsor 2, and a forward upper surface 3 configured to generate induced thrust. The lower surface 8 cavity 1 comprises a starboard side fence 4, a portside fence 4, and a trailing edge flap 6; the trailing edge flap 6 has a trailing flap edge 7. To achieve higher efficiencies, the vehicle is designed to operate with a lower surface 8 having an average surface pitch between 0° and 3°.

An approximate design criterion is for the pitch angle of the straight line 9 (or chord) connecting the leading edge of the vehicle to the trailing flap edge 7 at an angle between 0° and 3°. A more-rigorous design criterion is a flap and leading section designed with a straight line 9 of pitch between 0° and 3° connecting the forward stagnation point 10 to the trailing flap edge 7.

Preferred fence 4 positions are on the port and starboard sides of the cavity 1 at a height between 5% and 100% of the thickness of the lifting body, more preferably 10% to 50% of the lifting body thickness. The fences are preferably a vertical longitudinally-extending surface which may be augmented by vertical structures extending from the ground, such as railway tracks 11. Fences may deviate from vertical such as at an angle, curved, or formed as spaced from vertical surface extensions.

Preferably, the fence includes a forward surface designed, such as a deflector, to create induced thrust with a leading edge near the fence's inner surface with a fence-deflecting surface extending from the leading edge to the fence's outer surface. The design is configured to enable a higher pressure along the inner surface to promote oncoming air to deflect outward and over the fence-deflecting surface to create induced thrust. A trailing section of the fence includes a taper to promote higher pressures on the inner surface and overall neutral pressures (average pressure similar to free stream pressures) along the taper's surface.

Preferably, the longitudinally extending fence 4 is a sequence of fence sections 12 with each section configured to move vertically as a control surface. At a given sequence of vertical heights of fences, the vehicle will assume a steady-state flight position including a vehicle pitch and an angle in the roll dimension. When a fence section is moved upward, more lift pressures disperse laterally at a greater rate at that position, resulting in lower lift and a lowering of the vehicle at that position and any positions having lift pressure indirectly impacted. The vehicle will lower at the positions of lower lift leading to a new steady state vehicle pitch and roll angle; hence, the fence is preferably a vertically moving control surface. Thinner lower fence sections may slide in and out of thicker upper fence sections.

Preferably, the trailing flap 6 pivots or extends from a position on the lifting body by methods known in the art. The flap extends between a pair of fences. A lowering of the trailing flap edge 7 creates higher pressures in the cavity 1 and more lift. In the absence of vertical ground structures 11 augmenting fence functionality (e.g., a railway track), a good operating position is the trailing flap edge 7 at 70% of the vertical distance between the lifting body's trailing edge and the fence at that chord position. The trailing flap position is a results-driven parameter of vehicle operation. The trailing flap may be a laterally extending sequence of flap sections 12 between a pair of fences 4 5. Optionally, the trailing flap may extend from a contiguous connection with the underbody to form a spoiler which is a non-contiguous connection. The spoiler is preferably positions so air flow from both the trailing taper and the underbody impacts the spoiler creating a spoiler trailing stagnation region with orientations which increase lift and substantially cancel induced drag of forward spoiler surfaces with induced thrust of trailing spoiler surface.

Any fence or flap section may optionally have independent control actuation 27 and independent shock-absorbing function by moving in response to contact with an outside surface. The fence is configured to move up and back while blocking loss of lift pressures. For example, adjacent faces of fences in close proximity can move while providing resistance to air flow.

GEM 5 may use a wheel assembly connected to the vehicle body where the wheel assembly consists of wheels connected to a portside fence section to create a clearance between the portside fence section and a path where vertical movement of the wheels creates a similar vertical movement of the portside fence. A bearing may be used in this connection.

A key factor to achieve higher L/D efficiency is induced thrust on a frontal surface 3; lower pressures and respective induced thrust are created by expansion of higher pressure along the stagnation line 9 upward. Lower pressure forms when air flow diverges from a surface such as a curved surface (FIG. 2) or when a transition occurs from a lower pitch surface (i.e., more negative) to a higher pitch surface. Induced thrust 3 subtracts from drag in L/D performance; hence, as drag decreases from small values of induced thrust 3 there can be large increases in L/D.

The most-preferred embodiment is configured to form a higher-pressure region extending from a trailing-edge stagnation point 60, through the cavity, and to the leading-edge stagnation point 10. The formation of this continuous underbody stagnation region is consistent with the trailing edge stagnation region extending from the ground to the vehicle underbody and a fence-ground clearance sufficiently low to prevent lateral dissipation of pressure from significantly depleting the pressure in the cavity.

The frontal section 3 induced thrust may be enhanced by an upper-surface propulsor 2 where the propulsor intake 15 creates a lower pressure on the upper surface which increases the rate of expansion from the stagnation line which causes greater velocities of divergence from frontal surfaces having shape to enhance this propensity.

Preferably the upper surface propulsor is configured and operated with the Lift Span surface and trailing taper to overcome boundary layer separation, direct flow along the trailing taper, and impact with the ground and undercarriage flow to create the trailing edge stagnation region extending from the ground to the vehicle underbody.

The transit system comprises a ground effect machine (GEM 5) said GEM 5 comprising a vehicle underbody surface, an upper-surface propulsor, a low-pitch intake surface, a high-pitch discharge surface, a forward deflecting surface, a control means, and a vehicle body extending from a leading edge to a trailing cavity surface; the GEM 5 further comprises a lower cavity bound by a) a portside fence, b) a starboard side fence, c) the vehicle underbody surface, and d) the trailing cavity surface; the high-pitch discharge surface is below an air flow discharge of the propulsor and consists of an average surface pitch of 15° and 50° degrees; the control means is configured to detect and maintain a GEM 5 minimum clearance with a path. Preferably, the high-pitch discharge surface is configured to generate a higher-pressure stagnation region extending from the trailing cavity surface to the ground, the higher-pressure stagnation region's pressure between 50% and 150% of free-stream-air's dynamic gauge pressure relative to the GEM 5.

More preferably, the transit system also comprises of a low-pitch surface located below the air flow intake of the propulsor and extends forward at least 0.3 chord lengths from the propulsor; and the high-pitch discharge surface is located below an air flow discharge of the propulsor and extending over at least 60% of the vehicle body thickness.

More preferably: the trailing cavity surface is a flap, the low-pitch intake surface has an average surface pitch between −1° and 1°, the propulsor is a ducted fan having an upper surface extending less than 20% of the vehicle body's length (chord), the low-pitch intake surface is contiguously connected to a lower surface of the ducted fan, and the high-pitch discharge surface: a) extends rearward over at least 80% of the vehicle body thickness, b) has a pitch variance less than 5°, and c) is contiguously connected to a lower surface of the ducted fan.

Devices that enhance the performance of the base case ground-effect lifting body include:
a) Trailing-edge flap comprising a sequence of laterally-extending flap sections, b) an upper surface comprised of a sequence of flat surfaces 16, c) a variable-pitch lift-span 17, d) a crossover propulsor 18, e) a panel surface 19 extending at least half the vehicle chord and at least one third the vehicle width, f) a towed platform 20, g) a trailing taper 21, h) laterally-extending wings 22 with optional ailerons 23, i) slats 24 configured to increase the camber of a lifting body when extended, j) a mid-chord cavity flap 25, k) a mid-chord cavity morphing surface 26, 1) vertical control actuation 27 of fence sections 12, m) forward-extending fences 28, n) a second pair of fences 29, o) an aerial tail 30, p) a hydrofoil tail 31, q) a fence hydrofoil 32, r) the fence comprised of a plurality of sequential fence sections 12, s) a fence air or water ski 33, t) a fence wheeled ski 34, u) a ductless focusing fan 35, v) an inboard chambered panel 36 comprising an inboard cambered panel between two outboard lifting body fuselage 37, w) shock-absorbing fence sections 38, slats 39, and flaps which optionally include shock-absorbing embodiments in retraction/extension track assemblies 44 45. Here, the chamber 53 is a space below a concave downward panel which has sides that may or may not be fences.

Vehicle categories of this invention include but are not limited to: a) A marine aircraft, b) A railway car 40, c) A subway car, d) A roadway vehicle, e) A piecewise flat platform vehicle 41, f) An all-terrain vehicle, g) A ship, h) A boat with boat hulls 42 43, i) a guideways system (tracks, terraced guideway, overhead electric assembly), j) trucks, k) cars, 1) propulsion-assist trailers, and m) specialty agricultural vehicles like crop sprayers and aerial seeders.

For GEM 5 versions operating on paths designed for wheeled vehicles, the weight is preferably suspended by both aerodynamic lift (from the cavity) and wheel suspension with sufficient wheel suspension to provide traction (steering and/or thrust) and regenerative braking.

Preferably, the GEM 5 is designed to increase wheel suspension as part of braking to enhance braking traction; increased wheel suspension would result from reduced aerodynamic lift and could be used to increase weight on existing wheels or engage additional wheels or tracks in the braking process.

Extra braking 54 preferably engages with a reduction of lift suspension such as a wheel or track that contacts the ground for braking as part of a braking sequence consisting of reducing aerodynamic lift followed by contacting the extra braking 54 with a manifestation of the ground.

Intermodal Embodiments-Lateral control on highways preferably includes tire traction augmented with aerial yaw control devices such as rudders, especially rudders incorporated on fences. Hi-wheel embodiments may be used to provide yaw path control in intermodal operation between roadways and railways. Fence rudders using aerodynamic forces to engage rails are most-preferred for yaw-path control over rails.

Configured to Generate Induced Thrust-For instant invention, a leading section (i.e., leading 25% of the lifting body) configured to generate induced thrust has a leading edge on the lower 25%, preferably 15% of the surface and a surface that continuously, or stepwise continuously, has decreasing pitch as the surface proceeds upward and rearward from the leading edge. Preferably, greater than 80% (more preferably, greater than 90%) of oncoming air flows upward from the stagnation surface (i.e., stagnation line in 3D) and over the leading section including diverging flow from the surface which creates lower pressures on some upper surfaces having pitches less than 0° (more preferably, from 45° to 0°). Lower leading-edge stagnation points can promote more leading section induced thrust where a continuous underbody stagnation region deflects more oncoming air flow upward with more diverging flow from a deflector surface area.

Shock-Absorbing Extendable Slats-Slats, fences, and flaps are downward extensions of a lifting body; they offer the following advantages: a) enabling the lifting body, slats, fences, and flaps to operate at different clearances; b) enabling fast-actuating vertical movement of fences, slats, and flaps to avoid hitting the ground (i.e., the use the momentum of the lifting body to counter the momentum of fast actuation), c) reducing shear at low clearance relative to the entire lower surface of the lifting body being at that clearance, d) enabling shock-absorbing mechanisms to allow contact with the surface as a mode of operation or as a minor versus major perturbation, and e) enabling the vehicle to change aerodynamics for free flight versus ground-effect flight.

An advantageous change in surfaces to change aerodynamics is to increase the camber of a wing, fuselage, or other lifting body for ground-effect flight. Highly concave (e.g., a camber greater than 0.03) lower surfaces rely on the expansion of higher pressures from the lower surfaces of the trailing section to the lower surfaces of the leading section to create lift throughout the entire lower surface. In free flight, those lift pressures dissipate before reaching the lower surfaces of the leading section with resulting low L/D efficiency. In ground effect flight with fences and ground block losses of lower surface lift pressure, higher L/D are attainable. The general description of this embodiment is a vehicle having surfaces configured to operate at high-camber lower surface concave-downward surfaces when close to the ground and a lower-camber lower surfaces when flying distant from the ground. Flaps and slats can be used to increase the lower surface camber.

Preferred embodiments have slats that extend or pivot to increase camber of lower surfaces from less than 0.02 (concave downward) to greater than 0.03 (concave downward. FIG. 15 illustrates a curved track assembly 44 with two roller connections that allow the slat 24 to provide an extended configuration (FIG. 15a) with increased camber for ground-effect flight and a retracted position (FIG. 15b) with lower camber for free flight. Methods known in the art can provide shock-absorbing capabilities along the track travel path or at the connection between the track assembly 44 and the hull 42 43.

Fence Control Actuation-Efficiency of GEM 5 increases as the clearance ratio (CR) decreases. The preferred actuation is active fast vertical movement of fence sections with an algorithm consisting of the steps: a) detection on oncoming bump/wave, b) calculation of timing to move fence section upward to avoid the bump/wave, c) return of fence section, and d) repeat of process for subsequent fence sections encountering the wave/bump. Preferably, superimposed over this algorithm is a control algorithm adjusting other control surfaces (e.g. ailerons, other fence sections) to maintain a smooth ride.

A preferred fence includes a lower surface characterized as a ski with upward force provided by wheels, air, or water on the lower surface of the ski. Wheels, air, or water on the lower surface of the ski, which are attached to the fence, sustain from 0% to 20% (preferably 0.5% to 4%) of the vehicle weight with most of the vehicle weight supported by lift pressures (from aerodynamic forces) on the vehicle. The advantage being that the close clearance ratios are maintained with a low Ski drag due to the low weight supported by the Ski. Methods known in the art may be used to design fences with wheels, skis on snow, skis on water, and skis on water with air injection. Fences are designed to restrict air from flowing through the fence and the fence-vehicle interfaces. The ski may have a narrow long cavity 1 to create aerodynamic lift below the ski to buffer impact and reduce drag.

Fences with lower ski surfaces may be designed for a preferred state with the ski engaging the surface or with the ski as an approach to better absorb inadvertent contact with the surface; in either case, performance can be improved with high-speed controlled actuation of the extent of vertical extension of fence sections. A fence control inner algorithm is comprised of the following sequence: a) detection of on-coming ground level, b) calculation of timing for raising or lowering fence sections to maintain a set point clearance above the ground level, and c) movement of fence sections to match ground level. Superimposed over this inner algorithm is a second-tier algorithm to move the lifting body up and down in the case of severe changes in ground level. Superimposed over both of these algorithms is a third algorithm that inputs available input into an AI calculation algorithm designed with the objective function of creating a smooth ride. The second and third algorithms use additional control surfaces of flaps, slats, and ailerons to move the lifting body up or down.

Lift Span Tech-An upper-surface propulsor 2 intake 15 creates low pressures on upper surfaces which create lift; those same lower pressures can create form drag or induced thrust 3. For a trailing section propulsor, at about 0.75 c, higher pitches are preferred at low propulsor power to reduce boundary layer separation when gliding. At higher propulsor power, the propulsor dominates boundary layer phenomena and a lower pitch surface at the intake (e.g., −0.1°) is preferred. The lower pitch surface at the intake reduces or eliminates form drag and reduces the amount of resistance the surface has on air flow into the propulsor. Preferred is an intake surface that exhibits decreasing pitch with increasing propulsor power. The term “Lift Span” 17 is used to refer to the surface afore an upper surface trailing section propulsor intake 15 which experiences lower pressures due to the propulsor, and the term “Lift Span Tech” is used to refer to embodiments that reduce the pitch of the surfaces afore propulsor intakes 15 with increasing propulsor power.

The related invention embodiment is an aircraft comprising a variable pitch Lift Span 17 afore an upper-surface propulsor 2 where the variable pitch Lift Span 17 is an upper surface configured to operate at decreasing average surface pitch with increasing thrust of the upper-surface propulsor 2. It is not uncommon for the pitch of the entire aircraft to decrease with increasing speed. The preferred aircraft is configured for the average surface pitch of the variable pitch Lift Span 17 to decrease relative to the aircraft chord pitch with increasing thrust of the upper-surface propulsor 2.

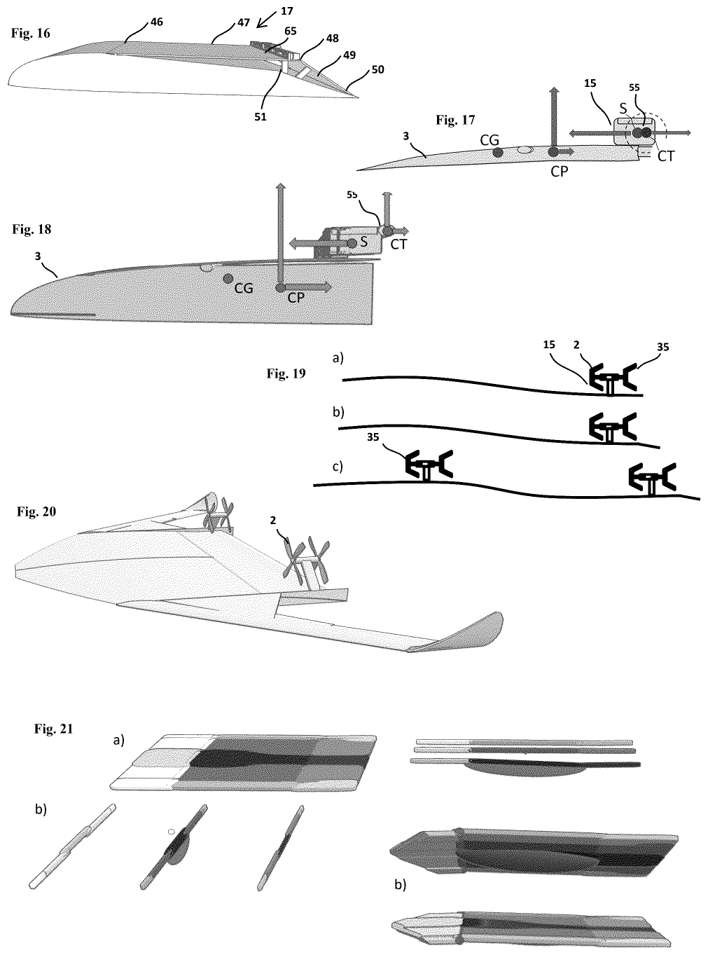

A passively-adjusting Lift Span 17 device is illustrated by FIG. 16 and is comprised of a contiguous connected sequence of a) a forward connection to the aircraft 46, b) a Lift Span surface 47, c) an upper-surface propulsor 2, d) a pivotable connection 48, e) a trailing taper panel 49, and f) a contiguous sliding contact 50 with the trailing section of the aircraft. The passively adjusting Lift Span 17 device includes a spring or similar elastic device 51 connecting the passively-adjusting Lift Span surface 47 device to the aircraft. For active control, the spring may be replaced with active control actuators. Also, the elastic aspect of the device may be incorporated into the Lift Span 17 surface such that lower pressures stretch the surface upward toward overall lower pitch; such elastic surfaces may be referred to as morphing surfaces.

Single-Sheet Planform, Folding Wing, and Cross-Over Propulsor Embodiments—Air may be forced into the cavity 1 to increase pressure beyond that expressed by oncoming air's dynamic pressure relative to vehicle velocity. This can be achieved with a cross-over propulsor 18, where a lifting body comprising a propulsor, an upper surface afore the propulsor, and a panel 19 aft the propulsor is configured with the propulsor intake 15 above the upper surface and the discharge below the panel 19. The preferred propulsor is a ducted fan and the panel 19 is a rearward extension of the upper surface of the ducted fan.

Preferably, the panel 19 is a convex upward cambered panel 19 consisting of thickness to chord ratio less than 0.1 [preferably between 0.005 and 0.02] and a camber between 0.02 and 0.12 [more preferably between 0.04 and 0.08]; this is referred to as a high-cambered span 52. Preferably, the high-cambered span is an inboard panel 19 span between two outboard fuselage spans 37.

The cross-over propulsor 18 is an effective method to extend a platform surface of an aircraft. FIG. 7 illustrates a lead aircraft 56 and a towed platform 20 connected through a pivotable connection 55 where a cross-over propulsor 18 is part of the transition from the lead aircraft to a towed platform 20. The lead aircraft comprises of the propulsor and the towed platform 20 comprises of the panel 19. Said panel 19 has a camber greater than 0.02. The towed platform 20 is configured to operate with a balance of lift and panel 19 center of gravity coupled with the leading lifting body by a pulling force acting through the pivotable connection. When the panel is a bifacial solar panel 57, the towed platform 20 may be configured to collect considerably more energy than is needed to sustain the flight of the towed platform 20.

Single sheet construction is advanced with the crossover configurations of FIGS. 8, 13, 26b, and 28, FIG. 18, and FIG. 28. The single-sheet construction embodiment comprises a lateral device such as a humerus spar 76 or propulsor assembly. Quill ribs 64 extend longitudinally from the lateral device to provide semi-rigidity. Single sheets attach to the quill ribs 64 and to a contiguous connection on the lateral device. Example contiguous connections include a clamp, rivets, bolts, screws, and surfaces fastened with adhesive. Actuators 78 provide control and transition.

FIG. 26 provides over-under comparisons of a crossover propulsor (31a) to a Lift-Span propulsor (31b). The upper surface of the crossover propulsor may provide a contiguous connection to a trailing bifacial sheet with a connecting bracket connected to a pivot connection toward enhancing stability and ease of manufacturing. The Lift Span propulsor provides a contiguous connection to a trailing taper surface toward via a connection, that may be under actuation, toward providing a truncated chord length to reduce fuselage height. The Lift Span Tech may be configured to increase the change of surface pitch from the surface in front of the propulsor to the trailing taper surface to increase left or to reduce drag, often consistent with the passive configuration of FIG. 16.

A trailing lifting body configured comprising a photovoltaic sheet is an example of a towed platform that is light weight toward the purpose of collecting energy for use by a leading vehicle. In the broader sense the leading vehicle is a leading propulsion surface such as: a) an aircraft, b) a boat, c) a railcar, d) a truck, e) a tractor-trailer, f) a car and g) an aircraft wing. FIG. 25 illustrates a railcar with a propulsor that is both a crossover propulsor and a lift-span propulsor, which in its capacity as a crossover propulsor discharges air under a trailing lifting body comprising a photovoltaic sheet. The invention summarized in the following paragraphs.

A vehicle comprises a leading propulsion surface and a trailing lifting body where the trailing lifting body comprises a photovoltaic sheet configured to generate lift on both the upper and lower surface of the photovoltaic sheet; wherein, the trailing lifting body is configured to operate at an average pitch that is variable relative to the average pitch of the leading propulsion surface; and wherein, the solar power generated by the trailing lifting body is greater than the power needed to sustain flight of the trailing lifting body. More specific details of the vehicle may include:
a) the leading propulsion surface is a flight vehicle and the connection is a pivotable connection configured to allow torque forces on the trailing lifting body to passively balance;
b) the pivotable connection may be configured to limit the difference in average pitch between the lead vehicle and trailing lifting body to no more than a 4 degree difference;
c) the excess power generated from the trailing lifting body may provide supplemental power to the lead vehicle;
d) the excess power generated from the trailing lifting body is preferably used for at least one from the list: a) sustaining chemical reactions, b) powering surveillance technology, c) powering communication technologies, d) monitoring weather conditions, e) charging a battery, and f) powering a propulsor;
e) an additional lifting body may be added in sequence to the trailing lifting body as a photovoltaic sheet configured to generate lift on both the upper and lower surface of the photovoltaic sheet in sequence;
f) any photovoltaic sheets may be bifacial photovoltaic sheets;
g) the trailing lifting body may have control surfaces, such as ailerons, to control pitch, roll, and yaw;
h) the trailing lifting body produces at least twice as much power as the power needed to overcome the drag of the trailing lifting body, more preferably at least four times as much power as needed to overcome the drag of the trailing lifting body, and even more preferably at least twenty times as much power as needed to overcome the drag of the trailing lifting body;
i) the vehicle's maximum width is less than half the vehicle's maximum length, where in terms of aspect ratio, the overall aspect ratio of the vehicle is preferably less than 0.5, but at least less than 1.0;
j). the trailing lift body is a cambered lifting body having an average body thickness less than 5% of the maximum length of the trailing lifting body;
k) the leading propulsion surface may be configured to support the trailing lifting body in a retracted configuration and wherein the vehicle is further configured to extend the trailing lifting body aft the leading propulsion surface;
l) the trailing lifting body may be a semirigid sheet with the leading half of the trailing lifting body being structurally stiffer than the trailing half of the trailing lifting body, and wherein the trailing lifting body is a thin chambered lifting body configured to passively decrease in camber with increasing velocity of travel through air.

A crossover propulsor may be used to improve performance of the towed platform vehicle, where additional specific details of the vehicle may include:
m) a leading propulsion surface upper surface has an aft edge connected to a ducted fan; the ducted fan comprising: i) a duct lower inner surface said duct lower inner surface contiguously connected to the aft edge and ii) a duct upper inner surface; where the trailing lifting body surface comprises a lower surface in contiguous connection with the duct upper inner surface; wherein, the ducted fan is configured to: a) increase lift on the leading propulsion surface upper surface and b) increase lift on the lower surface of the trailing lifting body;
n) the addition of a lower portside fence and a lower starboard fence extending downward from the lower surface of the trailing lifting body to further maintain the lift forces from the discharge of the duct.

Lift span technology at the trailing section of the trailing lifting body may be used to further increase lift-drag ratio efficiency, where additional specific details of the vehicle may include:
o) a trailing upper-surface propulsor having a propulsor discharge located within 0.3 chord lengths of the trailing edge of the trailing lifting body wherein the trailing propulsor is configured to increase lift forces on upper surface of the trailing lifting body.

The configurations are consistent with methods, including:
p) A method for increasing the lift drag ratio of a vehicle comprising a leading lifting body surface, a trailing lifting body surface, and a ducted fan; the method comprising the steps:
   a) accelerating the vehicle to attain air flow over the leading lifting body,
   b) intaking air from over the leading lifting body into the ducted fan,
   c) discharging air under the trailing lifting body surface from a discharge of the ducted fan, and
   d) changing the average pitch of trailing lifting body to balance upward lift forces on the trailing lifting body with downward weight on the trailing lifting body. This method may comprise at least one of the following mechanisms: a pivoting mechanism between the leading lifting body surface and the trailing lifting body surface and b) a semirigid configuration comprising decreasing rigidity in the aft-ward direction along the trailing lifting body.
q) A fabrication method for the vehicle comprising a leading lifting body surface, a trailing lifting body surface, and a ducted fan, the fabrication method comprising: a) fabricating a ducted fan with a first connection on a forward lower duct surface and a second connection on the trailing upper duct surface, b) attaching the leading lifting body surface to the first connection, and c) attaching the trailing lifting body surface to the second connection; wherein the trailing connection is configured to pivot about a laterally extending axis.

The most-preferred GEM 5 obtaining substantial operation in free flight are comprised of gimbal wings that transform to form fences. In the transformation horizontal laterally-extending surfaces are re-aligned to form vertical longitudinally-extending surfaces.

The invention includes a gimbal wing extending outward said gimbal wing comprises a humerus spar configured to pivot about a shoulder joint from a spanwise extension to a cavity fence position. The shoulder joint may be configured to rotate in a wing pitch control actuation. A wing propulsor may be located below a wing root section located between the vehicle body and a shoulder joint, and the wing propulsor may be configured as a crossover propulsor with discharge in a side cavity 63 comprising a vehicle body side and a gimbal wing section in a fence position. Wings may use quill ribs 64 extending from the humerus spars 76 rearward wherein lift surfaces extend laterally between adjacent quill ribs 64; design features of a quill rib may be similar to design features of a feature's quill.

Folding and gimbal wing embodiments may use bifacial photovoltaic cells as sheet lift surfaces. The gimbal joints may include an elbow joint connecting the humerus spar to a radius spar where the GEM 5 is configured to move the radius spar from an outward-extending radius wing position to a longitudinally-extending radius fence position. Gimbal wing roots may be connected to a high-pitch discharge surface with a taper pivot connecting the body to the high-pitch discharge surface; the shoulder joint 77 may connect the humerus spar to the high-pitch discharge surface; the cavity fence position may extend spanwise longitudinally from the shoulder joint with a fence lower edge near 0° pitch; and the high-pitch discharge surface may pivot from a free flight position to the GEM 5 configuration.

FIG. 8, FIG. 9, and FIG. 13 illustrate lower wingspan configurations where the wing folds down via shoulder joints. FIG. 13 has particular utility for single-sheet construction such as low aspect ratio aircraft using single-sheet bifacial photovoltaic sheets to collect solar power. The GEM 5 may include a portside fence configured to generate induced thrust on at least one third the leading surface of the fence with a trailing fence taper surface extending from the side fence surface rearward and outward.

GEM 5 Folded Wing Configuration and Algorithms-In an algorithm for GEM 5 takeoff; preferably, a locking mechanism locks the wing tip in a vertical position next to the body to reduce vibration and decrease air leaks between the fence and body. The vehicle may be lowed with the wings extended, and so, prior to takeoff the wings are placed and locked into the GEM 5 position. Velocity is increased until the wheels clear the ground; whereby, optionally, a hovercraft mode may be used to avoid use of wheels. Wheels may be on the fences and wheels may be on the body. After takeoff the wings are unlocked from the fence position and wingtips are lowered no lower than a minimum pre-determined ground clearance. The wings are spread in a controlled manner.

The controlled manner avoids boundary layer separation by keeping the air divergence (i.e., air angle of attack) below a minimum value and avoids the sudden increase in drag. The controlled algorithm be a statical control function based on the specific aircraft and operating conditions. The controlled algorithm may be a feedback control based on sensor input such as pressure measurements at locations known to correlate with the onset of boundary layer separation. When wings are fully extended they may be locked in position with affirmation of control by ailerons or flaps.

A method for operating the GEM 5 with an upper surface propulsor includes takeoff to free flight may comprise the steps: (a) placing wing sections in a fence position configured for, (b) accelerating to takeoff velocity and attaining of ground effect flight, (c) lowering wing section wing tips as elevation increases and while maintaining a minimum ground clearance, and (d) extending wings to a lateral wing position configured for efficient free flight. This free-flight GEM 5 has a lower cavity defined by two fences in the fence position, a vehicle body lower surface, and a trailing flap.

An additional method for transit comprises the GEM 5 configured to transition from transit on a railway path to transit on a roadway where the GEM 5 comprises an upper surface propulsor and a lower cavity; the lower cavity preferably comprises side fences and a trailing flap where the flap configuration is changed from a vertical distance of at lead one half inch above the wheels on a highway to a vertical distance of at least one inch below the wheels on a railway track. The GEM 5 travels at a speed greater than 60 mph on the railway to attain better efficiencies.

Control Algorithm—The control algorithm for wing transition from take-off ground effect to free-flight may consist of a dynamic sub-algorithm controlling trailing flaps, ailerons, fence sections, and morphing upper cavity surface for maintaining moment coefficient for stability. This sub-algorithm designed to modify listed surfaces to prevent pitch deviation dependent on changes in ground conditions, wind speeds, and weight distribution. The algorithm is designed to distribute lift forces along the cavity upper surface to maintain smooth and safe flight during wing and elevation transitions.

Railcar Embodiment-The ground-effect railcar embodiment has particularly good performance due to the ability to travel at low clearance gap ratios resulting in high L/D efficiency. At locations where traffic is high, additional blocking of lateral losses, from upper and lower surfaces, can be achieved with railway side walls 58 along the sides of the tracks positioned for preferred lateral vehicle clearances of 0.3 to 1.5 feet. An overhead LIM 59 may be used as a safeguard against derailment and may be part of a guideway separate from the tracks.

Typically, a clearance is a vertical distance, however, over rails the fence may extend over the side of the rail.

The transit system of this invention may comprise GEM 5 with side propulsors connected to the vehicle body and configured to increase the velocity of air along the side of the vehicle from a first leading tunnel section 68 to a first trailing tunnel section 69. A duct sequence 70 preferably connects a first leading tunnel section 68 to a second trailing tunnel section 71 where the duct sequence 70 are configured to use air's dynamic pressure create an air flow from the second trailing section to the first leading section. This is most useful for operation with open vehicle entrances to and from tunnel sections designed to operate at lower pressures where the leading section extends to a first leading section tunnel exit 72 and the second trailing section extends from a second trailing section tunnel entrance 73. A GEM 5 and a transit path the transit system preferably comprises a tunnel, a tunnel entrance section and a tunnel exit section; the tunnel entrance section being connected to said tunnel exit section by a sequence of air passages configured to convert entrance air's relative dynamic pressure into flow through the sequence of air passages from the tunnel entrance section to the tunnel exit section.

A LIM is able to provide non-contact propulsion with the preferred LIM 59 being overhead a vehicle and also providing: a) energy transfer, b) partial suspension, and c) tractor-type guidance along a LIM cable. More preferably, an overhead electrical assembly consists of an upper LIM cable and a lower contact cable; the contact cable configured to transfer electrical power to conventional trains which may operate on the same tracks.

Free Flight—Free flight is away from ground effects. In free flight the fences are typically retracted and the flap set at a lower setting.

The transit system of this invention may or may not include a path 74 of ground-effect flight. The transit system includes a means to interact with the path 74 which may be on the GEM 5 in part or in whole. The path 74 is a manifestation of the ground surface such as a railway, roadway, or water surface.

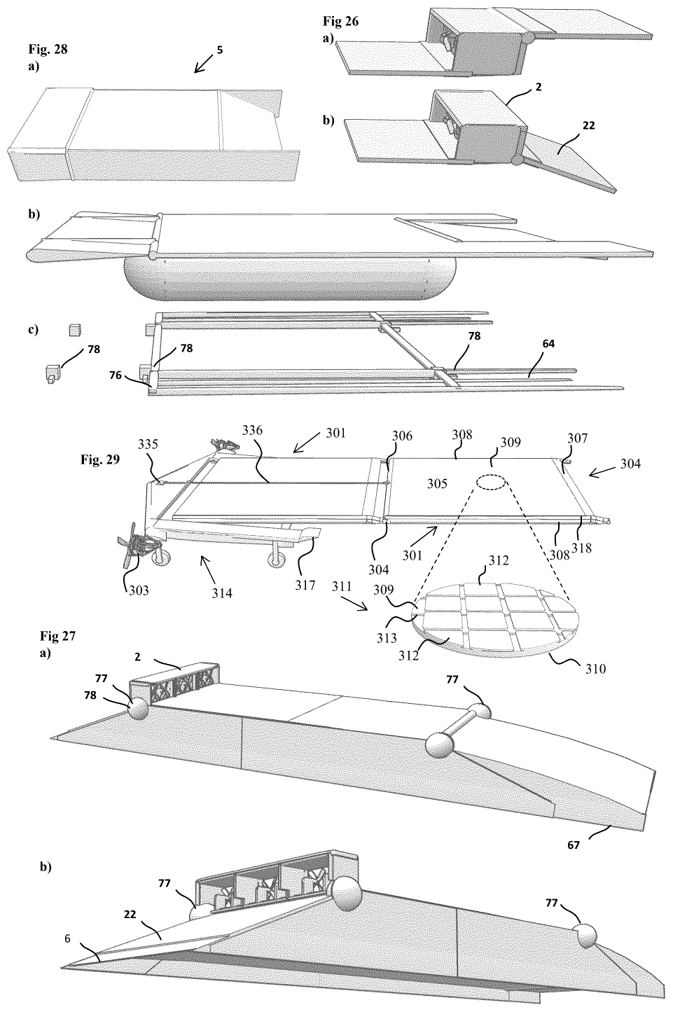

FIG. 27 illustrates a GEM with shoulder joints to fold wing from free flight to fence positions. The fence-position wings are contiguous with a GEFT fuselage consistent with transition on rails and roadways including roads blocked off to allow the GEM to takeoff and land. The FIG. 27 GEM embodiment is capable of high-lift high-L/D-efficiency ground-effect flight in the GEM configuration consistent with the many pre-print papers of the Illustrative Example section, including L/D efficiency in excess of 30. Also, the FIG. 27 GEM is capable of extending wings, with gimbal action to achieve wing of good span and high aspect ratio with commonly attainable L/D efficiencies in excess of 12.

Preferably, a GEM 5 designed for extended free flight comprises a wing section and a shoulder joint connecting the wing section to the vehicle body where the wing section pivots about the shoulder joint longitudinally and vertically from a lateral wing position to a longitudinal fence position. More preferably, the wing section comprises a long-chord section extending spanwise outward from the vehicle body and a short-chord section extending spanwise inward over the vehicle body.

Latches may be used to secure the wing sections in fence positions, such as a magnetic latch. Overlap of section may be used to provide contiguous air flow or to increase structural strength, such as a section of a wing section resting on a fuselage upper surface when the wing section is expanded in span for free flight.

The GEM 5 may be configured as an electric vehicle for operation on a highway wherein at least half the weight is supported by aerodynamic lift and, optionally, with solar panels on a payload compartment providing at least half the propulsion power at a cruising speed greater than 50 mph.

The GEM 5 may comprise a lead vehicle pulling a trailer with regenerative braking and electric wheel propulsion where at least half the trailer weight suspension in air-based ground effect flight suspension, and optionally an upper surface propulsor 2 on said trailer precedes a trailing taper 22 having a surface pitch between 15 and 70 degrees. Preferably, photovoltaic cells on the ground effect machine provide more than 25% of the power required to transport a cargo-less system; more preferably, more than 50% of the power.

The GEM 5 may be configured as an agricultural vehicle where the agricultural vehicle interacts with farm ground in a ground effect flight mode of operation. The agricultural GEM may be used for crop spray, aerial seeding, and other operations.

GEM wing extensions may have sections that are primarily fence section to avoid interference in free flight. The flat wing sections with sharp corners smoothed removed is one of many shapes which can be optimized specific to application. Morphing shapes are an option.

Supersonic flight may be achieved in ground effect where the shock wave bounces off the ground and back onto the lower surface. For supersonic aircraft, the about of fuselage above the leading edge is reduced, preferably with a near-horizontal apex near the leading edge and a convex upper surface camber. Crossover propulsors may be used to reduce accumulation of shock wave near the leading edge.

Solar Embodiments-A solar cell array 57 towed where torque passively balances about the forward joint 4 at the more-preferred pitch is able to collect greater than 20× the power needed to sustain flight (overcome drag). Example sheet 105 materials are a canvas, a metal sheet, a composite sheet, a corrugated plastic, and a corrugated board all characterized by a low thickness.

Multiple aerial towed platforms 011 may be pulled by one lead aircraft 114 forming an aerial train which reduces form drag while having flexibility that increases robustness. FIG. 3 illustrates separate components that form an aerial train. FIG. 14 illustrates a thin cambered wing section aircraft where multiple plates 101 are stacked to provide a more-robust structure for takeoff and landing FIG. 4 provides a close-up illustration of the side 8 and a stacked side.

FIG. 24 illustrates an application of the platform 101 alternative to solar aircraft. The distributed load of that platform 101 is distributed through a forward lateral structure 122 and a trailing lateral structure 123 where the forward lateral structure 122 pivotally connects to a forward arm 124 of a swaywing 125 on the lower aerodynamic surface 110. The trailing lateral structure 123 pivotally connects to a trailing arm 126 of the swaywing 125 on the lower aerodynamic surface 110. The swaywing 125 system is connected to a payload 129 compartment. In this configuration, a lateral tensile stress with a convex-upward camber is formed on the sheet 105 between the lateral structures 122 123 due to the lift forces. This camber structure is also light in weight and facilitates high L: D, provided the camber arc is minimal. U.S. Patent Appl. No. 16/783319 provides further discussion of the swaywing.

Thin plate construction can be relatively inexpensive. Other advantages reside in the plate materials. Transparent plates can provide stealth. Laminates with a conductive layer (sheet or grid) sandwiched in insulation can provide electrical connectivity for an aircraft, including control signals superimposed of electrical power transmission (see FIG. 23). Also, sheets may have conductive tracks that are insulated from each other but with ability to connect to electrical devices on the aircraft; this allows for elimination of wires and provides a robustness when tracks are wide and redundant.

A vehicle according to various aspects of this present invention employs an aerial towed platform 301 comprising a thin cambered wing section 305 pivotally connected to a propulsion means having a propulsor 303 through a forward joint 304. FIG. 29 is an example embodiment of an aerial vehicle while FIG. 25 is an example embodiment of a vehicle which remains in contact with ground in transit. The thin cambered wing section 305 comprises a sheet 305, a rounded leading edge 306, a trailing edge 307, an average chord length, two sides 308, an average span between the sides 308, and a distributed load. The sheet 305 has an upper aerodynamic surface 309 for generating lift and a lower aerodynamic surface 310 for generating additional lift. The thin cambered wing section's average chord length is greater than its average span.

The ground vehicle of FIG. 25 is illustrated with multimodal railway-highway capabilities. Along the upper surface is the following progression starting with the leading edge: a) air flows over a forward section deflector, b) air pressure decreases as it approaches the intake of a propulsor which is preferably a ducted fan, and c) the propulsor pushes air over a trailing taper and below a trailing towed platform which comprises preferably a thin cambered wing section which can be retracted to a position over the leading vehicle. Air flowing over the trailing towed platform decreases in pressure as it approaches a trailing propulsor on the platform. The trailing towed platform is preferably retracted over the leading vehicle at velocities less than 30 mph and is preferably deployed at velocities greater than 65 mph. The preferred vehicle has photovoltaic cells on the upper surface of the leading vehicle and, bifacial photovoltaic cells as the primary planform area on the towed platform. The photovoltaic cells are able to provide power for vehicle propulsion, and preferably, the photovoltaic cells provide at least 30% of the energy needed for vehicle propulsion so as to significantly reduce battery costs and weight for electric versions of the vehicle. More preferably, the photovoltaic cells provide more than 60% of the energy needed for propulsion. Up to 100% replacement is possible on sunny days, especially for empty vehicles. Example vehicles for using this technology are railcars and trucks; for trucks the streamlined vehicle of FIG. 25 is an alternative to a box track or semi-truck with a box trailer.

FIG. 30 is a cross section of the preferred configuration for a trailing-section ducted fan using lift span technology which has a near-zero average pitch on the surface in front of the ducted fan intake and a trailing taper after the ducted fan discharge. Lift span tech may optimally have an increased wing section thickness to express the performance feature of the lift span in front of the ducted fan and the taper after the ducted fan.

A preferred distributed load is an evenly distributed load comprising an array 311 of solar cells 12 on the upper aerodynamic surface 309 of the sheet 305 with the array 311 comprising a circuit 13 connecting the solar cells 12. Preferably, the propulsion means is at least of one of a lead aircraft 314, a linear motor 315, and a tractor. Preferably, the forward joint 304 is at least one of a hinge joint, a pin joint, and a ball joint. FIG. 1. illustrates a lead aircraft 314 pulling the aerial towed platform 301.

For a substantially low camber sheet 305 with an evenly distributed load, the weight of the distributed load is equal and opposite lift locally and on the larger scale. This substantially eliminates stress on the sheet 305 during steady-state flight allowing use of light-weight sheet materials without structural reinforcement. This reduces load, reduces pitch, increases L:D, and leads to high energy efficiency. Preferred loads on the platform 301 is less than 5 lb per ft², more preferably less than 2 lb/ft², and most preferably less than 0.5 lb/ft².

A solar cell array 311 towed where torque passively balances about the forward joint 304 at the more-preferred pitch is able to collect greater than 20× the power needed to sustain flight (overcome drag). Example sheet 305 materials are a canvas, a metal sheet, a composite sheet, a corrugated plastic, and a corrugated board all characterized by a low thickness.

Multiple aerial towed platforms 301 may be pulled by one lead aircraft 314 forming a aerial train which reduces form drag while having flexibility that increases robustness. FIG. 3 illustrates separate components that form a aerial train. FIG. 3 illustrates a thin cambered wing section aircraft where multiple platforms 301 are stacked to provide a more-robust structure for takeoff and landing FIG. 4 provides a close-up illustration of the side 308 and a stacked side.

Towed configurations are inherently stable in pitch provided the forward joint 304 is toward the leading edge 306 of the towed platform 301. Preferably, the forward joint 304 is in the front 25% of the platform; more preferably within the front 10% of the platform 301 or even extended in front of the leading edge. In this configuration, aerodynamic forces generate lift torque that balances load at the more-preferred steady-state flight pitch without need for active control of the pitch angle. While a towed platform has passive pitch, roll, and yaw stability; a preferred aerial towed platform 301 has a control means 316 comprising at least one of ailerons 317, flaps, and a horizontal stabilizer. Most-preferred is use of ailerons to reduce chaotic variation (e.g. response to turbulence) in the platform 301 pitch.

Preferably, the aerial towed platform 301 has sides 308 of vertical inclination wherein the sides 308 are at least one of guideways 318, fences 319, sealing air pocket perimeter 320, and guiding protrusions 321. Vertical components of sides 308 create resistance to lateral air flow.

The FIG. 4 illustration is side 308 design capable of being 3D-printed. For a 3D-printed side, the protrusion 321 may be a nub of plastic and the same side 308 may provide a guideway 318, fence 319, protrusion 321, and perimeter 320 to trap air between stacked platforms 301. Trapping of air between stacked platforms 301 can create a hovercraft type of action when extending or retracting platforms 301. Example guiding protrusions 321 are selected from a group wheels, slides, nubs, balls, and knobs that may follow a guideway 318. Example guideways are rails, raceways, and grooves.

Thin cambered wing Section Aircraft—A problem with the rectangular thin cambered wing sections is pitch instability during takeoff. If this instability is not addressed, the nose of an aircraft could flip up and over the trailing edge during takeoff. A preferred solution is a thin cambered wing section aircraft comprising a landing gear system 327, an energy storage means 328, a control system 316, a payload 329, and a tiltwing 330 pivotally connected to a primary thin cambered wing section platform 331 by a forward joint 304. The tiltwing 330 is comprised of at least one tiltwing wing section 332, at least one propulsor 303, and a pitch control means 316; the energy storage means 328 is configured to power the propulsor 303; and the control system 316 is configured to control both the propulsor 303 and the tiltwing 330 pitch. Example vehicles with towed platforms are provided by FIGS. 3, 6, 7, 10, 11, 14, 21, 22, 25, 28, and 29; the preferred platforms comprise thin cambered wing sections.

In this embodiment, the pitch of the primary thin cambered wing section platform 331 is lower than the tiltwing 330 pitch at a runway takeoff velocity since aerodynamic forces lift the trailing edge of the thin cambered wing section platform 331 relative to its forward joint 14. Preferably, the tiltwing 330 has at least one of flaps, ailerons 317, and horizontal stabilizers wherein the control means 316 controls at least one of roll, pitch, and yaw.

Preferably, a pivot resistance device 341 limits the degrees of pitch of the thin cambered wing section 305 relative to the tiltwing 330 to less than 45 degrees. Examples of a pivot resistance devices includes hinge springs, pads 333, bumpers, and springs; all of which functionally limit the degree with the thin cambered wing section is able to rotate relative to the tiltwing 330.

Preferably, the pivot resistance devices 341 include at least one pad 333. Preferably, the landing gear system 327 is attached to the tiltwing 330, and the thin cambered wing section 305 rests on the pad 333 when the thin cambered wing section aircraft is parked. In this embodiment, tiltwing 330 is broadly defined as a device including a wing attached to a propulsor; and more specifically in this embodiment, it is substantially an aircraft in its own right where that aircraft is able to pivot to positive pitch relative to the thin cambered wing section (see FIG. 3).

For this thin cambered wing section aircraft, preferably, a second towed platform 334 is stacked above the primary thin cambered wing section platform 331, and the second towed platform 334 is extended behind the primary thin cambered wing section platform 331 during flight. Preferably, the thin cambered wing section aircraft includes a towed platform extension means 344 said towed platform extension means 344 comprising a guideway 318, a winch 335, a cable 336, and a guiding protrusion 321 said guiding protrusion 321 functionally following the guideway 318. Preferably, the payload 329 is attached to the tiltwing 330 and is at least one of batteries, fuel cells, fuel tank, communication electronics, radar, imagery equipment, aircraft hangar, aircraft, hydrogen tank, passenger cabin, freight compartment, pod transfer devices, passenger transfer cabin, spacecraft launcher, and chemical production process. The tiltwing 330 embodiment goes beyond the traditional definition of a tiltwing, up to and the option for including air frame, landing gear, and payload features as part of the tiltwing 330.

Flying Towed Platform Aerial train-A flying towed platform aerial train is comprised of a lead aircraft 314 followed by a primary aerial towed platform 331 followed by at least a second aerial towed platform 333. The primary aerial towed platform 331 includes a primary thin cambered wing section platform 331, a forward joint 304, a first forward connection 337, and a first aft connection 338; the second aerial towed platform 333 includes a second towed platform 334 and a second forward connection 339; and the primary and secondary thin cambered wing section platforms 331 333 are preferably aerial towed platforms 301 as described in first paragraph of Invention Description. The towed platform aerial train includes at least the first forward connection 37 pivotally connected to the lead aircraft 314 and the second forward connection 339 pivotally connected to the first aft connection 338.

The preferred flying towed platform aerial train includes arrays 311 of solar cells 312 on the upper aerodynamic surfaces 309 of the sheets 305 where the arrays 311 include at least one circuit 313 connecting the solar cells 312. At least one circuit 313 connects to the lead aircraft 314, and the solar cells 312 provide electrical power to the lead aircraft 314. The most preferred flying towed platform aerial train includes a payload 329 connected to the lead aircraft 314 Longer aerial train units may be formed by adding more platforms 301 connected similar to how the secondary platform 333 is connected to the primary platform 331 as illustrated by FIG. 6. When stacked on the primary thin cambered wing section platform 331, platforms higher in the stack may rest on those lower in the stack on pads attached to sheets of an average thickness to provide weight support through to a support structure under the primary platform 331. These pads may be of a low-friction material to allow platforms to slide off during extension. Also, an air pocket may be created between platforms to assist with extension by opening an air inlet between platforms with a resistance to air leaving the space between platforms by a sealing perimeter (e.g. like a hovercraft). Various locking mechanisms and keys along the cable may be used to sequentially extend the platforms in flight. It is also possible to attach platforms delivered by a delivery vehicle during flight. Platform average thickness is preferably less than one fifth the platform's width, more preferably less than on tenth.

When extending, protrusions 321 follow the guideways 318 first in a parallel path to the lower platform, but at the end of the guideway, the guideway bends downward so that sequential platform sheets are aerodynamically aligned (see FIG. 5). Methods known in the science and art may be used to provide smooth and streamlined air flow along platforms in a aerial train sequence. A bumper 340 on the trailing end of the guideway stops further extension, and can form a pivotable joint in combination with a protrusion 321 and guideway 318.

Preferably, a fuselage thin plate platform 45 is attached to the bottom of the fuselage 44 and is configured substantially parallel to the aerial towed platform 301. The performance advantage of this transportation system 41 is a high L: D within a narrow transit corridor. The combined low pitch surface areas of the two platforms 301 45 and the fuselage's upper low-pitch surface 309 approximately double the low-pitch aerodynamic lift area. The highest L:D is achieved when the two platforms 301 45 are substantially parallel. An approximate doubling of overall L: D, due to a doubling of low-pitch surface areas, approximately doubles the fuel economy as compared to the fuselage and lower platform 45 alone.

Preferably: the forward arm 42 and trailing arm 43 are of equal length and parallel; the two platforms 301 45 have spans at least 50% greater than the median width of the fuselage 44; and both platforms 301 45 have fences 319 as part of their sides 308 to reduce lateral air flow.

More preferably, the two platforms 301 45 have median spans between 1.5× and 3× the median width of the fuselage 44.

The gap between the fuselages upper surface 309 and the towed platform's 1 lower surface 310 decreases as velocity increases and the fuselage 44 swings back and up. The two surfaces may contact at higher velocities. Preferably, the maximum gap is between 0.4× and 3× the parked median pitch displacement of the upper platform 301 where pitch displacement is approximately the median length of the platform 301 multiplied times the pitch angle in radians. Preferred parked platform pitch angles are between 2 and 10 degrees and more preferably between 3 and 7 degrees. Cruising pitch angles are preferably between 0.2 and 5 degrees, and more preferably between 0.5 and 3 degrees.

Initial pitch angles are set by the length of a trailing motor connection 46 (between the towed platform 301 and the linear motor 15) relative to the forward motor connection 47. The pitch of the linear motor 15 is a reference value of zero. The trailing connection 46 may decrease in length (e.g. elastic or comprising a spring) to decrease the pitch of the towed platform 301 as velocity increases. At rest, the linear motor 15 may support the weight of both platforms 301 45 and the fuselage. The forward motor connection 47 comprises a forward joint 304 as previously described, and the forward motor connection 47 may include an arm to increase initial space between the linear motor 15 and the towed platform 301.

The towed platform includes a thin cambered wing section. The lift-drag ratio, desirably, tends to increase in the following sequence of design parameters: a) as the camber is increases from zero to a camber in the range of 0.01 to 0.06, b) with a crossover propulsor at the leading edge of a towed platform with discharge air flow directed under the towed platform, and c) with addition of lift span technology which includes an aerial propulsor at the trailing section of the upper surface of the trailing end towed platform.

Aerial Trains-Longer aerial train units may be formed by adding more platforms 101 connected similar to how the secondary platform 133 is connected to the primary platform 131 as illustrated by FIG. 6. When stacked on the primary thin cambered wing section platform 131, platforms higher in the stack may rest on those lower in the stack on pads attached to sheets of an average thickness to provide weight support through to a support structure under the primary platform 131. These pads may be of a low-friction material to allow platforms to slide off during extension. Also, an air pocket may be created between platforms to assist with extension by opening an air inlet between platforms with a resistance to air leaving the space between platforms by a sealing perimeter (e.g. like a hovercraft). Various locking mechanisms and keys along the cable may be used to sequentially extend the platforms in flight. It is also possible to attach platforms delivered by a delivery vehicle during flight. Platform average thickness is preferably less than one fifth the platform's width, more preferably less than on tenth.

When extending, protrusions 121 follow the guideways 118 first in a parallel path to the lower platform, but at the end of the guideway, the guideway bends downward so that sequential platform sheets are aerodynamically aligned (see FIG. 5). Methods known in the science and art may be used to provide smooth and streamlined air flow along platforms in a aerial train sequence. A bumper 140 on the trailing end of the guideway stops further extension, and can form a pivotable joint in combination with a protrusion 121 and guideway 118.

Flying Aerial train Overhead Monorail—The FIG. 24 transportation system 141 is comprised of a linear motor 115 propelling along an overhead monorail, an aerial towed platform 101 (as described in first paragraph of Invention Description) pivotally connected to the linear motor 115, and a swaywing 125 connection between the aerial towed platform 101 and a fuselage 144. The fuselage has a median width. The swaywing 125 is comprised of a forward fuselage arm 142 pivotally connecting a forward upper aerodynamic surface 109 of the fuselage to a forward lower aerodynamic surface of the aerial towed platform 101, a trailing fuselage arm 143 pivotally connecting a trailing upper aerodynamic surface 109 of the fuselage to a trailing lower aerodynamic surface of the aerial towed platform 101, and an air gap between the aerial towed platform 101 and the fuselage. As the linear motor pulls the platform 101 forward, forward velocity induces aerodynamic lift on both the aerial towed platform 101 and the fuselage 144 wherein the fuselage 144 swings toward the aerial towed platform 101.

Front Tiltwing—In one embodiment, tiltwing 130 is broadly defined as a device including a wing attached to a propulsor; and more specifically in this embodiment, it is substantially an aircraft in its own right where that aircraft is able to pivot to positive pitch relative to the thin cambered wing section (see FIG. 14).

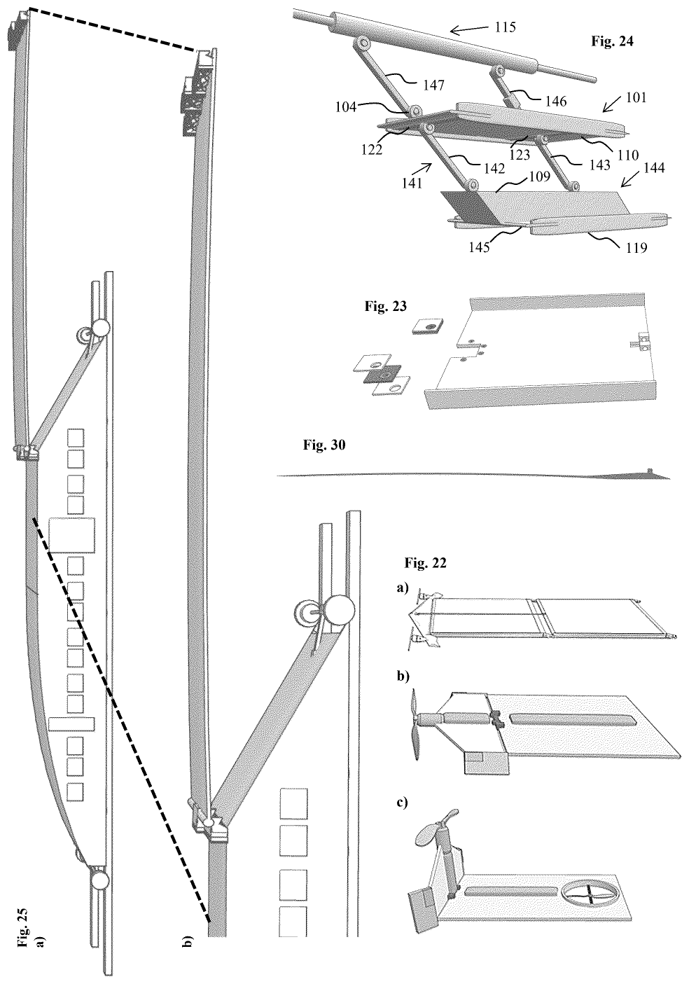

Three features tend to be common between the aerial towed platforms embodiments of the previous paragraphs and transformer drone embodiments of the following paragraphs. Firstly, the embodiments rely on lift paths for aerodynamic lift more than laterally-extending fixed wings. Secondly, a front tiltwing is preferred. Thirdly, most transformer drone embodiments have a platform with a forward joint connecting to a front tiltwing. And so, many of the configurations described for a transformer drone may be practiced on a vehicle comprising an aerial towed platform, and vice versa such as illustrated by FIG. 22.

FIG. 22c illustrates a trailing propulsor which has an orientation that is preferably coupled to the orientation of the front tiltwing through a cable, push rod, or other means running along the towed platform.

Contiguous Connectivity—Connecting surface of this invention are preferably contiguous to air flow unless otherwise indicated. By example, a trailing taper is contiguous in connection to a lower inner duct surface wherein the said trailing taper has an average pitch between 15 and 50 degrees and the ducted fan discharge is within 0.3 chord lengths of the leading propulsor surface trailing edge. Also, a fabrication method comprising a continuous photovoltaic sheet may include: a) attaching the ducted fan to the upper surface of the continuous photovoltaic sheet; b) attaching the continuous photovoltaic sheet to: i) a vehicle frame leading-edge connection, ii) a vehicle frame trailing-edge connection, and iii) a vehicle frame surface that conforms the continuous photovoltaic sheet to a change of angle at the discharge of the ducted fan wherein the change of angle forms a taper having an average pitch between 10 and 40 degrees.

Illustrative Example of Folding Wing Embodiment—FIG. 4 illustrates two examples of how an extended wing may fold into fence positions for ground-effect flight, takeoff, and landing.

Parametric Ranges—Parametric ranges are identified for ground-effect flight with free flight or floating in water optionally operating outside the preferred ranges for ground-effect flight. Important design parameters include the following:
a. Trailing taper is important. The trailing taper 22 reduces vehicle length whereby shorter vehicle length makes it easier for higher cavity pressures to expand forward and increase induced thrust where: a) for free flight preferred trailing tapers are between 3° and 20° with 15° to 20° range most preferred for cruising and b) in ground-effect flight preferred trailing tapers are between 15° and 50° with 25° to 40° range most preferred for cruising. Variable pitch is preferred to allow optimal performance as dependent on propulsor power. The trailing taper extends over at least 60% of the body height, and preferably, from the upper surface of the body to the lower surface with contiguous connection to a flap that extends below the vehicle lower surface. Most-preferred in ground-effect is a flat taper surface which translates to a pitch consisting of a variance of less than 2°. Variances less than 5° allows camber as may be preferred for certain applications.
b. A typical good flap percent is 70% of the gap between the lifting body's trailing edge and the lower part of the fence at the flap location, and preferably for ground effect flight, the flap percent is able to vary between about 20% and to about a clearance about twice that of the fence. Note that if the fence is above railway tracks, the flap may extend below the tracks in the space between tracks. In free flight, a zero percent flap or upward deflection may be preferred.
c. Fences extend downward from the body 37 with the body height defined independently of the fence's downward extension from the body's lower surface. The clearance ratio is the minimum clearance from the ground divided by the fence height (from lower fence edge to the lower surface of the lifting body). Preferably: a) fence heights are typically 5% to 100% of the body height, b) the fence extends forward to at least the leading edge of the body, and c) the fence extends backward to at least the flap. Fence geometry parameters are subject to results-driven optimization. In steady-level ground-effect flight, the fence is preferably a constant clearance value (e.g. 0.01 clearance ratio for railcar) for both fences throughout the length. As a control method, the fence clearance may be increased resulting in local cavity pressure reduction and a change in roll or pitch, depending upon location and coordination of changes in clearance ratio. By example, a GEM railcar may be designed to operate at a clearance ratio of 0.01 at 70 mph to generate a lift pressure that is 80% of air's oncoming dynamic pressure; where, as the velocity increases the clearance ratio increases to keep the average lift pressure about the same since the railcar weight is relatively constant during a trip.
d. The pressure in the cavity increases with increasing GEM velocity and decreasing clearance ratio; and so, at a constant vehicle weight and preferred near-constant pressure throughout the cavity the clearance ratio will increase with increasing velocity after the desired aerodynamic lift force is attained. A typical design point is for full aerodynamic lift at about 70 mph at a clearance ratio of 0.02. Example “desired aerodynamic lift” are: a) 100% of the weight for takeoff to free flight, b) 90% of weight for GEM operation with wheel traction, and c) 90% of weight for GEM operation with water ski traction.
e. Control surfaces vary considerably between a GEM truck, a GEM aircraft designed for free flight, and a GEM boat. For a truck, the preferred control surfaces are wheels with conventional steering mechanisms and braking mechanisms. Ailerons, flaps, vertical stabilizers, and horizontal stabilizers may be added as deemed optimal for GEM designed for free flight; and specific to inventions herein, GEM with a lead body pulling a towed platform have good passive stability characteristics. For GEM boats, ski orientation is a control surface for steering as is the weight on the ski for braking. For GEM railcars, hi-rails may be used as well as: a) ailerons, b) rudders on fences, c) sections of the flap, and d) fence clearance. Rapid vertical movement of fence sections may be used to avoid hitting upward perturbations from an otherwise flat surface (e.g. such as speed humps, carrion, rocks, and wave crests).
f. Lift Span surfaces in front of a Lift Span propulsor preferably have a pitch that varies with propulsor power, where for cruising speeds, the preferred average pitch of the 30% of body chord length in front of the propulsor is −1° and 1°.
g. Tunnel pressures are a degree of freedom with optimal tunnel operating pressures depending on the distance of travel in the tunnels and the traffic density; more Bernoulli Loops lead to lower tunnel pressures.

Illustrative examples are contained in the following series of pre-print materials published after priority documents and before instant application, but after stated provisional applications. These documents contain multiple illustrative examples, calculations, and explanations of underlying theory and design approaches.

The preprint https://doi.org/10.33774/coe-2024-76mzx entitled “Critical Data and Thinking in Ground Effect Vehicle Design” illustrates the importance of adjustable fences and control on attaining L/D efficiencies exceeding 40. Said preprint illustrates the improvement from these compared to patent No. GB1347352 GEM with L/D of 11 to 17.

The preprint https://doi.org/10.33774/coe-2024-w4qtp entitled “An Airfoil Science Including Causality” illustrates the importance of developing leading and trailing edge stagnation points 10 60 for the development of strong lift forces and induced thrust without significant irreversible energy losses.

The preprint https://doi.org/10.31224/4224 entitled “Overcoming Boundary Layer Separation” illustrates the importance of the trailing stagnation region 60 reaching from the path to the cavity trailing surface for the formation of ground effect efficiencies of L/D exceeding 25, and readily between 15 and 25 for digital prototypes. Said preprint illustrates the importance of upper-surface propulsor in increasing efficiency through the mitigation of boundary layer separation turbulence losses over the trailing taper, increasing L/D efficiency by 100-200%. Said preprint illustrates effective use of trailing taper pitch surfaces higher than 30 degrees pitch. Example energy savings exceed 50% energy consumption due to drag reduction and reduced wheel suspension using technologies of this invention with example loads up to 277 lb/ft at 50 mph.

The preprint https://doi.org/10.21203/rs.3.rs-4670250/v2, “Computational Analysis of Towed Solar platforms” illustrates the importance of the −1 to 1 degree pitch for the low-pitch upper surface of claim 2 for achieving high L/D efficiency. The preprint also illustrates the importance of developing the trailing stagnation point 60 to develop lift pressures through the use of a spoiler as the cavity trailing surface. The preprint illustrates the excess energy capabilities of trailing sections (i.e., towed platforms) of aero vehicles, with estimates of power generation over 150 times the power needed to sustain flight of the towed section.

The preprint https://doi.org/10.31224/4136 entitled “Thin Cambered Lifting Bodies in Ground-Effect Flight” illustrates that GEM consisting partially of thin cambered sheet sections generate the same or better lift forces per surface area with readily increasing aspect ratios than GEFT GEM. L/D of said thin camber inboard sectional GEFT exceed 40, readily attaining L/D of 20-35, and wing sections of thin camber in ground effect exceed 80 L/D with upper-surface trailing propulsors. This work illustrates how a low aspect ratio boat can be expanded spanwise by expanding an inboard thin-cambered section; this expansion increases lift while preserving L/D efficiency toward allowing a ship to attain free flight. Example changes in aspect ratios are from a range of 0.2 to 0.4 to a range of 0.5 to 2.0; where the chord remains approximately constant.

The preprint https://doi.org/10.33774/coe-2024-2c87q entitled “Ground Effect Flight Transit (GEFT)-Approaches to Design” illustrates the importance of induced thrust on the leading section of the cavity's upper surface. Said preprint illustrates GEFT with L/D greater than 60 with upper surface trailing propulsors.

The preprint https://doi.org/10.33774/coe-2024-prxvr “Ground Effect Flight Transit (GEFT)—Towards Trans-Modal Sustainability” illustrates the importance of adjustable portside fences, starboard fences, and trailing flaps on propagating trailing edge stagnation point 60 dynamic pressures through the cavity for improved lift. The paper illustrates the capabilities of wing sections of the transport system of claim 13 to function on roads, railways, and canals with L/D 40-60 readily attained.

The preprint https://doi.org/10.33774/coe-2024-6w01w entitled “Ground Effect Flight Transit (GEFT) in Subways” illustrates the importance of maintaining the pressure before a GEM at a pressure equal to or less than the pressure behind a GEM to attain wing section L/D efficiencies 20-30 within enclosed spaces.

The conference paper referenced Suppes, A., and Suppes, G., “Highly-Efficient Low-AR aerial vehicles in urban transit,” Proceedings of the 2014 Transportation Research Board Annual Meeting, January, 2024, hs-drone. com illustrates the design of Bernoulli loops to efficiently link multiple transit tunnels to maintain the favorable pressure differentials of said preprint entitled Ground Effect Flight Transit (GEFT) in Subways.”

The following are illustrative examples of the improvements from camber, trailing lifting bodies, upper surface trailing propulsors on trailing lifting bodies, and the benefits of cross-over sources between leading planforms and trailing lifting bodies. Simulation results illustrate that a 0.04 thickness to chord ratio at 0.4 aspect ratio has an L/D of 4.6 increased to 6 with a trailing taper source compared to an expected L/D of 2.5 for a flat plate as calculated from the AR equation.

Simulation results illustrate that a 0.04 thickness to chord ratio at 1 aspect ratio has an L/D of 7.3 without a source and increased to 8.4 with an upper surface trailing source compared to an expected L/D of 6.3 from the AR equation for a flat plate.

Simulation results on a pair of cambered planforms each with at an aspect ratio of 2 for a total combined aspect ratio of 1 illustrates the beneficial properties of an upper surface trailing propulsor on the trailing lifting body and a cross-over source between the two lifting bodies. For a configuration with a low power crossover source between the planforms, the L/D without a trailing upper surface propulsor on the trailing lifting body is 7.7. The addition of an upper surface trailing propulsor on the trailing lifting body increases this value to 12.8; further doubling the power of the trailing propulsor increases the L/D to 20.3. The addition of the upper surface trailing propulsor on the trailing lifting body both decreases the overall drag on the system and increase the overall lift.

Simulations on a similar system maintaining a constant power to the upper surface trailing propulsor on the trailing lifting body illustrate the impact of the cross-over propulsor. The results provide an L/D of 21.9 on with a low powered cross-over propulsor. Doubling the power of the crossover propulsor increases the system L/D to 23.1. Further doubling of the crossover propulsor power increases the system L/D to 26.2. Another doubling of the cross-over propulsor to match the power of the upper surface trailing propulsor on the trailing platform increases the L/D to 34. The overall lift of the system does not significantly increase as the cross-over propulsor increases, but the impact of the cross-over propulsor counteracts form drag on the trailing lifting body, reducing the drag coefficient on the trailing platform by a greater extent than the cross-over propulsor increases the drag on the forward platform. The cross-over propulsor provides important efficiency improvements through allowing the platforms to travel with reduced interference, but simulations at high cross-over propulsor powers provide effective negative drag for the trailing lift body portion of the vehicle system. These values may not be achievable in practice, suggesting a limitation to the benefits achievable from cross-over propulsors, but confirming they may provide some benefits for efficiency in towed platform functions.

The following is a summary of devices or terms that are different manifestations of the same thing: a) a deflector surface 1 may be configured to provide “induced thrust” on forward surface, b) a trailing cavity surface 6 is a surface designed to create pressure, and optionally, control the amount of pressure created and flow through a cavity. A flap 6 and a spoiler 6 are types of trailing cavity surfaces, c) a truck underbody 8 implicitly includes a truck lower surface 8, d) the lower-pitch intake surface 16 in front of a Lift Span propulsor may be referred to as a Lift Span 16 or flat intake surface 16, e) the crossover propulsors 18 of this invention may be thin plate crossover propulsors 18 when used with thin plate construction or a side propulsor 66 crossover propulsor when on the side of a vehicle with intake on an upper surface and discharge in a side cavity 63, f) a panel surface 19 includes more-specific options such as a sheet surface 19, a thin cambered surface 19, and single sheet bifacial photovoltaic surfaces 19, g). laterally extending wings 22 may be referred to as wing sections 22, h) an aerial tail 30 may be referred to as a boattail 30 or diffuser 30, i) a wheeled ski 34 may be referred to as a wheel assembly 34, and j) A curved track assembly 44 may be referred to as an extension track 44 for a slat.

1. A vehicle comprising a leading propulsion surface and a trailing lifting body said trailing lifting body comprising a photovoltaic sheet configured to generate lift on both the upper and lower surface of the photovoltaic sheet; wherein
the trailing lifting body is configured to operate at an average pitch that is variable relative to the average pitch of the leading propulsion surface; and wherein,
the solar power generated by the trailing lifting body is greater than the power needed to sustain flight of the trailing lifting body.

2. The vehicle of claim 1 wherein the leading propulsion surface is a flight vehicle and the connection is a pivotable connection configured to allow torque forces on the trailing lifting body to balance.

3. The vehicle of claim 2 wherein the pivotable connection is configured to limit the difference in average pitch between the lead vehicle and trailing lifting body to no more than 4 degrees difference.

4. The vehicle of claim 1 wherein electrical power generated from the trailing lifting body is connected to the leading propulsion surface.

6. The vehicle of claim 1 wherein the power generated from the trailing lifting body is used for at least one from the list: a) sustaining chemical reactions, b) powering surveillance technology, c) powering communication technologies, d) monitoring weather conditions, e) charging a battery, and f) powering a propulsor.

7. The vehicle of claim 1 wherein the trailing lifting body comprises control surfaces said control surfaces configured to control vehicle altitude.

8. The vehicle of claim 1 wherein the leading propulsion vehicle is at least one from the list: a) an aircraft, b) a boat, c) a railcar, d) a truck, e) a tractor-trailer, f) a car, g) an aircraft wing, and h) a tiltwing.

9. The vehicle of claim 1 wherein the trailing lifting body produces at least four times as much power as the power needed to overcome the drag of the trailing lifting body.

10. The vehicle of claim 1 wherein the vehicle's maximum width is less half the vehicle's maximum length.

11. The vehicle of claim 1 wherein the trailing lift body is a cambered lifting body having an average body thickness less than 5% of maximum length of the trailing lifting body.

12. The vehicle of claim 1 further comprising a leading propulsion surface upper surface with an aft edge connected to a ducted fan;
the ducted fan comprising: i) a duct lower inner surface said duct lower inner surface contiguously connected to the aft edge and ii) a duct upper inner surface; and
the trailing lifting body surface comprising a lower surface in contiguous connection with the duct upper inner surface; wherein,
the ducted fan is configured to: a) increase lift on the leading propulsion surface upper surface and b) increase lift on the lower surface of the trailing lifting body.

13. The vehicle of claim 1 further comprising a trailing upper-surface propulsor having a propulsor discharge located within 0.3 chord lengths of the trailing edge of the trailing lifting body wherein the trailing propulsor is configured to increase lift forces on the upper surface of the trailing lifting body.

14. The vehicle of claim 1 wherein the leading propulsion surface is configured to support the trailing lifting body in a retracted configuration and wherein the vehicle is further configured to extend the trailing lifting body aft the leading propulsion surface.

15. The vehicle of claim 1 wherein the trailing lifting body is semirigid with the leading half of the trailing lifting body being structurally stiffer than the trailing half of the trailing lifting body, and wherein the trailing lifting body is a thin chambered lifting body configured to passively decrease in camber with increasing velocity of travel through air.

16. The vehicle of claim 1 comprising a trailing taper contiguous in connection to a lower inner duct surface wherein the said trailing taper has an average pitch between 15 and 50 degrees and the ducted fan discharge is within 0.3 chord lengths of the leading propulsor surface trailing edge

17. A method for increasing the lift drag ratio of a vehicle comprising a leading lifting body surface, a trailing lifting body surface, and a ducted fan; the method comprising the steps:
a) accelerating the vehicle to attain air flow over the leading lifting body,
b) intaking air from over the leading lifting body into the ducted fan,
c) discharging air under the trailing lifting body surface from a discharge of the ducted fan, and
d) changing the average pitch of trailing lifting body to balance upward lift forces on the trailing lifting body with downward weight on the trailing lifting body.

18. The method of claim 17 comprising at least one of the following mechanisms: a) a pivoting mechanism between the leading lifting body surface and the trailing lifting body surface and
b) a semirigid configuration comprising decreasing rigidity in the aft-ward direction along the trailing lifting body.

19. A fabrication method for a vehicle comprising a leading lifting body surface, a trailing lifting body surface, and a ducted fan, the fabrication method comprising: a) fabricating a ducted fan with a first connection on a forward lower duct surface and a second connection on the trailing upper duct surface, b) attaching the leading lifting body surface to the first connection, and c) attaching the trailing lifting body surface to the second connection;
wherein the trailing connection is configured to pivot about a laterally extending axis.

20. The fabrication method of claim 19 comprising a continuous photovoltaic sheet comprising:
a) attaching the ducted fan to the upper surface of the continuous photovoltaic sheet; b) attaching the continuous photovoltaic sheet to: i) a vehicle frame leading-edge connection, ii) a vehicle frame trailing-edge connection, and iii) a vehicle frame surface that conforms the continuous photovoltaic sheet to a change of angle at the discharge of the ducted fan wherein the change of angle forms a taper having an average pitch between 10 and 40 degrees.
